(19) United States
(12) Patent Application Publication
(10) Pub. No.: US 2026/0298412 A1
(43) Pub. Date: Oct. 1, 2026

(54) AUTOMATICALLY OPENABLE AND CLOSABLE OVERPRESSURE HYDROGEN DISCHARGE APPARATUS FOR HYDROGEN ELECTRIC VEHICLE

(71) Applicants: Hyundai Motor Company, Seoul (KR); Kia Corporation, Seoul (KR)

(72) Inventor: JONGWOOK BACK, Hwaseong-Si (KR)

(21) Appl. No.: 19/305,210

(22) Filed: Aug. 20, 2025

(30) Foreign Application Priority Data
Mar. 28, 2025 (KR) 10-2025-0040357

(51) Int. Cl. F17C 7/00; F17C 13/04; H01M 8/04082; H01M 8/04701; B60L 50/70

(52) U.S. Cl. CPC F17C 7/00; F17C 13/04; H01M 8/04201; H01M 8/04708; B60L 50/70; F17C 2221/012; F17C 2225/0123; F17C 2260/021; F17C 2270/0168; F17C 2270/0184

(57) ABSTRACT

An apparatus for a hydrogen electric vehicle includes a first body configured as a housing that forms a gas flow path in a vertical direction. The first body comprises a pipe connection end at a lower portion connected to an overpressure hydrogen discharge pipe and an upper portion that is open at a top. A main stepped structure at a central portion defines a vertical passage between the pipe connection end and an internal space. A control plate above the main stepped structure partitions the internal space into upper and lower regions and includes a plurality of dispersion discharge holes. A lifting valve unit and a main cover connected through a lifting shaft are configured to open or close the upper portion of the first body.

### CROSS-REFERENCE TO RELATED APPLICATION

This present application claims the benefit of priority to Korean Patent Application No. 10-2025-0040357, filed on Mar 28, 2025, in the Korean Intellectual Property Office, the entire contents of which are incorporated herein by reference.

### TECHNICAL FIELD

The present disclosure relates to an automatically openable and closable overpressure hydrogen discharge apparatus for a hydrogen electric vehicle, and more particularly, to an automatically openable and closable overpressure hydrogen discharge apparatus that prevents chattering of a cover unit caused by a discharge pressure of overpressure hydrogen in a hydrogen electric vehicle, reduces physical impact or vibration applied to an outlet and the cover unit, and enables overpressure hydrogen to be smoothly discharged in a predetermined direction.

### BACKGROUND

The matters described in this Background section are only for enhancement of understanding of the background of the disclosure, and should not be taken as acknowledgement that they correspond to prior art already known to those skilled in the art.

A hydrogen electric vehicle may include a hydrogen storage tank for storing hydrogen and a fuel cell stack for generating electric energy using the hydrogen.

The electric energy generated by the fuel cell stack may be used as a power source for a drive motor, and a portion of the energy may be stored in a battery.

More specifically, hydrogen may be stored in the hydrogen storage tank in a compressed state under high pressure (e.g., approximately 700 bar). The hydrogen compressed at high pressure may be depressurized and then supplied to the fuel cell stack. The hydrogen compressed at high pressure may be depressurized to a predetermined pressure (e.g., approximately 20 bar) through a pressure reducing device.

The depressurized hydrogen may be supplied to the fuel cell stack through a predetermined pipe, and during this process, the depressurized hydrogen may pass through an overpressure prevention device.

The overpressure prevention device may be configured to monitor whether hydrogen compressed at high pressure is depressurized to a pressure within a predetermined range during a pressure-reducing process.

The overpressure prevention device may be configured to prevent hydrogen exceeding a predetermined pressure value from being supplied to the fuel cell stack.

To this end, the overpressure prevention device may be configured to monitor in real time a pressure of the hydrogen flowing toward the fuel cell stack. Based on detection of a pressure exceeding the predetermined pressure from the flowing hydrogen, the overpressure prevention device may be configured to immediately discharge a portion of the hydrogen to the outside, thereby reducing the hydrogen pressure in the pipe.

Overpressurized hydrogen may be discharged to the outside of the hydrogen electric vehicle through an overpressure hydrogen discharge pipe. An outlet of the overpressure hydrogen discharge pipe may be installed to face vertically upward in the hydrogen electric vehicle. The outlet of the overpressure hydrogen discharge pipe may remain closed with a cap under normal conditions.

However, a momentary high discharge pressure may form throughout the overpressure hydrogen discharge pipe based on overpressure hydrogen being detected by the overpressure prevention device and subsequently discharged through the overpressure hydrogen discharge pipe.

Accordingly, the cap or a lid structure provided at the upper end of the overpressure hydrogen discharge pipe may be easily damaged or lost due to the momentary discharge pressure generated during the discharge of the overpressurized hydrogen.

If the outlet is not covered by the cap or the lid structure, foreign substances may enter the overpressure hydrogen discharge pipe, resulting in blockage or narrowing of a hydrogen discharge pipe.

Accordingly, a technical solution to address these issues is considered.

The following summary presents a simplified summary of certain features. The summary is not an extensive overview and is not intended to identify key or critical elements.

The present disclosure is directed to providing a solution to an issue in which a cap of an outlet may be damaged or lost during the discharge of overpressurized hydrogen.

In addition, the present disclosure is directed to providing a solution to an issue in which chattering may occur due to the interaction between the flow of overpressurized hydrogen from the outlet and the cap structure.

Further, the present disclosure is directed to providing a solution to an issue in which overpressurized hydrogen discharged through an outlet may enter the vehicle body of a hydrogen electric vehicle.

Still further, the present disclosure is directed to providing a solution to an issue in which foreign substances may enter an exposed hydrogen outlet, resulting in blockage or narrowing of a hydrogen discharge pipe.

According to the present disclosure, an apparatus for a hydrogen electric vehicle, the apparatus comprising a first body configured as a housing that forms a gas flow path in a vertical direction, wherein the first body comprises a pipe connection end, wherein the pipe connection end is provided at a lower portion of the first body and connected to an overpressure hydrogen discharge pipe, and wherein the first body comprises an upper portion that is open at a top of the first body, a main stepped structure formed at a central portion of the first body, wherein the main stepped structure defines a passage of a predetermined size that extends vertically, and wherein the passage is configured to provide a gas flow path between the pipe connection end and an internal space of the first body, a control plate provided above the main stepped structure, wherein the control plate has a predetermined thickness, wherein the control plate is configured to partition the internal space of the first body into an upper region and a lower region, and wherein the control plate comprises a plurality of dispersion discharge holes that are vertically open, a lifting valve unit provided in a space between the main stepped structure and the control plate, wherein the lifting valve unit is configured to be in contact with a top peripheral surface of the main stepped structure to close the passage, and configured to, based on an external force greater than a predetermined magnitude being applied upwardly, ascend and open the passage, and a main cover connected to the lifting valve unit through a lifting shaft, wherein the main cover is configured to move upward and downward together with the lifting valve unit to open or close the upper portion of the first body.

The lifting valve unit may comprise a second body, wherein the second body comprises a lower surface formed as a flat sealing surface, and an upper surface, wherein the upper surface is formed as an upper corresponding surface that faces upward and in parallel with the flat sealing surface, and wherein at least a portion of a lower end of the lifting shaft is vertically inserted into a central portion of the upper corresponding surface and coupled to the second body.

The lifting valve unit may comprise an elastic unit, wherein the elastic unit may be configured to, based on an external force greater than the predetermined magnitude being applied upwardly to the flat sealing surface of the second body, be elastically deformed in a space between the upper corresponding surface and a lower surface of the control plate to cause the second body to ascend, and the elastic unit may be further configured to absorb stress in a vertical direction during the deformation of the elastic unit, and configured to be restored, based on removal of the external force, to an original shape of the elastic unit such that the flat sealing surface of the second body returns to close the passage defined by the main stepped structure.

The lifting valve unit may comprise a guide stopper extending from the upper corresponding surface to a predetermined height, and the guide stopper may be configured to be in contact with and encompassing an outer circumferential surface of the lifting shaft with a predetermined thickness.

The guide stopper may be configured to limit a peak height to which the second body is allowed to ascend toward the control plate.

The second body may comprise a horizontal fastening hole that is laterally formed through an interior portion of the second body, wherein the lifting shaft comprises a screw fastening hole that is formed in a lower end portion of the lifting shaft, wherein the lower end portion is inserted into the second body in a direction perpendicular to the upper corresponding surface, wherein the screw fastening hole is positioned to align with the horizontal fastening hole, and wherein the second body and the main cover are fixed to each other by a fastening screw that extends across the horizontal fastening hole and the screw fastening hole.

The control plate may comprise an opening formed at a central portion of the control plate to allow the lifting shaft to pass vertically along a longitudinal direction of the lifting shaft, and wherein the plurality of dispersion discharge holes are formed in radial regions around a center point of the lifting shaft, such that gas passes through the control plate with a uniformly distributed flow rate.

A cross-sectional area of the passage defined by the main stepped structure may be greater than a total cross-sectional area of the plurality of dispersion discharge holes of the control plate.

The main cover may comprise a peripheral projection configured to be in contact with a top peripheral surface of the first body and cover the top peripheral surface of the first body, a sealing groove formed around a lower portion adjacent to the peripheral projection in parallel with the peripheral projection, wherein the sealing groove has a predetermined width, and a closing member inserted into the sealing groove, wherein the closing member is configured to surround the lower portion of the peripheral projection and configured to seal, based on the main cover being in a state that covers the upper portion of the first body, the internal space of the first body from an external environment.

The main cover may comprise a sealing inclined surface formed on a lower portion of the peripheral projection and adjacent to the sealing groove, wherein the sealing inclined surface is inclined inward as the sealing inclined surface extends downward, and an upwardly curved surface formed between the sealing inclined surface and the lifting shaft along an inner circumferential edge of the sealing inclined surface, wherein the upwardly curved surface is radially inclined upward as the upwardly curved surface extends farther from the lifting shaft.

The first body may comprise an upward expansion portion formed in a predetermined length region of an inner circumferential surface along an inner circumferential edge of the upper portion that is open at the top of the first body, wherein the upward expansion portion comprises an inclined surface that is upwardly expanded such that a cross-sectional area of the gas flow path increases toward the upper portion.

According to the present disclosure, an apparatus of a hydrogen electric vehicle, the apparatus comprising a housing comprising a lower end and an upper end, wherein the lower end is configured to be connected to a hydrogen discharge pipe, a main stepped structure disposed inside the housing and defining a vertically extending passage between the lower end and an internal space of the housing, a control plate positioned above the main stepped structure within the housing, wherein the control plate comprises a plurality of dispersion discharge holes that extend in a direction perpendicular to the control plate, a sealing piston disposed between the main stepped structure and the control plate, wherein the sealing piston comprises a lower surface and an upper surface, wherein the lower surface of the sealing piston is configured to seal the vertically extending passage, and wherein the upper surface of the sealing piston is spaced apart from the control plate in a rest position, a spring disposed between the upper surface of the sealing piston and a lower surface of the control plate, wherein the spring is configured to be compressed based on the sealing piston being displaced toward the control plate, a lifting shaft fixed at a lower end to the sealing piston and extending upward through a central opening in the control plate, a main cover fixed to an upper end of the lifting shaft and positioned above the housing, wherein the main cover is configured to close the upper end of the housing in a rest position and move upward together with the lifting shaft based on the sealing piston being lifted by hydrogen pressure, and an annular gasket disposed between the main cover and the upper end of the housing, wherein the annular gasket is configured to be compressed to form a seal in a rest position and separated during upward movement of the main cover.

The lifting shaft may be secured to the sealing piston by a fastening screw that passes through a horizontal hole formed in the sealing piston and a screw hole formed in a lower end portion of the lifting shaft.

The apparatus may further comprise a guide stopper formed on the sealing piston, wherein the guide stopper surrounds the lifting shaft and is configured to limit upward movement of the sealing piston by contacting a lower surface of the control plate.

The spring may be a compression coil spring concentrically arranged around the lifting shaft.

The plurality of dispersion discharge holes may be distributed radially around the lifting shaft, and the control plate may comprise a total cross-sectional area of the plurality of dispersion discharge holes is smaller than a cross-sectional area of the vertically extending passage.

The sealing piston may be configured such that a circumferential surface of the sealing piston contacts an inner surface of the housing and slides vertically within the housing during upward and downward movement of the sealing piston.

The annular gasket may be positioned within a recessed groove formed in the main cover and is pressed against an upwardly inclined sealing surface formed on an inner wall of the housing.

The main cover may further comprise an upwardly curved surface formed between the lifting shaft and the annular gasket, wherein the upwardly curved surface is configured to direct discharged hydrogen flow outward and upward.

The housing, the sealing piston, the control plate, and the main cover may be each formed from stainless steel.

The effects of the present disclosure are not limited to those mentioned above, and other effects not mentioned can be clearly understood by those skilled in the art from the following description.

### BRIEF DESCRIPTION OF THE DRAWINGS

The foregoing and other examples, features, and advantages, as well as the following detailed description of the examples, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 shows an example of a hydrogen electric vehicle equipped with an overpressure hydrogen discharge apparatus according to one example of the present disclosure.

FIG. 2 shows an example of a mounting position and coupling relationship of an overpressure hydrogen discharge apparatus provided in a hydrogen electric vehicle according to one example of the present disclosure.

FIGS. 3A and 3B are perspective views respectively showing an example of a closed state and an open state of an overpressure hydrogen discharge apparatus according to one example of the present disclosure.

FIG. 4 is a sectional perspective view of an exemplary overpressure hydrogen discharge apparatus according to one example of the present disclosure.

FIG. 5 is a cross-sectional view of an exemplary overpressure hydrogen discharge apparatus according to one example of the present disclosure.

FIG. 6 is a sectional perspective view showing an exemplary open state of an overpressure hydrogen discharge apparatus according to one example of the present disclosure.

FIG. 7 is a sectional perspective view of an exemplary overpressure hydrogen discharge apparatus according to another example of the present disclosure.

FIG. 8 shows an example computing system.

### DETAILED DESCRIPTION

Hereinafter, some examples of the present disclosure will be described in more detail. However, the following examples are provided merely as references for describing the present disclosure in detail, and the present disclosure is not limited thereto and may be implemented in various forms.

Unless otherwise defined, all technical and scientific terms used in the present disclosure have the same meanings as commonly understood by those skilled in the art of this application. The terms "include," "comprise," and any variations thereof used in the specification of this application are intended to encompass non-exclusive inclusion.

In the description of the present disclosure, it shall be noted that, unless explicitly defined or limited otherwise, terms such as "mounted," "interconnected," "connected," etc., should be interpreted broadly. For example, they may be fixed connections, detachable connections, or integral connections, and they may be directly interconnected, or indirectly interconnected through intermediate media. Those of ordinary skill in the art should understand the specific meanings of the above-mentioned terms in the present application according to the specific situation.

The present disclosure may use ordinal numbers such as "first," "second," "third," etc., to refer to elements, and it should be noted that, unless explicitly indicated otherwise, these are merely used to distinguish between different elements and do not imply that the mentioned elements are necessarily provided in the indicated order in terms of time, space, or other examples.

When a component, unit, device, element, apparatus, or the like of the present disclosure is described as having a purpose or performing an operation, function, or the like, the component, unit, device, element, apparatus, or the like should be considered herein as being “configured to” meet that purpose or to perform that operation or function. Each component, unit, device, element, apparatus, and the like may separately embody or be included with a processor and a memory, such as a non-transitory computer readable media, as part of the apparatus.

The term “unit” or “module” used in this specification signifies one unit that processes at least one function or operation, and may be realized by hardware, software, or a combination thereof. The operations of the method or the functions described in connection with the forms disclosed herein may be embodied directly in a hardware or a software module executed by a processor, or in a combination thereof.

The term “module” or “unit” used in the specification means a software and/or hardware component, and the “module” or “unit” performs certain operations/functions/roles. However, the “module” or “unit” is not construed as being limited to software or hardware. The “module” or “unit” may be configured to be in an addressable storage medium or to execute one or more processors. Therefore, as an example, the “module” or “unit” may include at least one of components such as software components, object-oriented software components, class components, and task components, processes, functions, attributes, procedures, sub-routines, segments of program codes, drivers, firmware, micro-codes, circuits, data, databases, data structures, tables, arrays, or variables. Functions provided in the components, “modules”, or “units” may be combined into a smaller number of components, “modules”, or “units” or further divided into additional components, “modules”, or “units”.

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure.

For purposes of this application and the claims, using the exemplary phrase "at least one of: A; B; or C" or "at least one of A, B, or C," the phrase means "at least one A, or at least one B, or at least one C, or any combination of at least one A, at least one B, and at least one C. Further, exemplary phrases, such as "A, B, and C", "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

In the present specification, a first direction (X-axis direction), a second direction (Y-axis direction), and a third direction (Z-axis direction) are used to describe a three-dimensional structure in space, and respectively refer to directions orthogonal to one another.

The present disclosure relates to an automatically openable and closable overpressure hydrogen discharge apparatus 100 for a hydrogen electric vehicle 1.

The automatically openable and closable overpressure hydrogen discharge apparatus 100 for the hydrogen electric vehicle 1 according to one example of the present disclosure may be coupled to a hydrogen outlet of the hydrogen electric vehicle 1.

Specifically, the present disclosure relates to enabling a portion of hydrogen to be rapidly discharged from the hydrogen electric vehicle 1 to the outside when hydrogen needs to be released, and to preventing the discharged hydrogen from reentering the hydrogen electric vehicle 1.

In addition, the present disclosure relates to providing a structure in which a hydrogen outlet is opened only during hydrogen discharge and is covered under normal conditions to prevent foreign substances from entering the hydrogen outlet.

Further, the present disclosure relates to protecting a hydrogen outlet and a cap structure from a momentarily increased discharge pressure during hydrogen discharge.

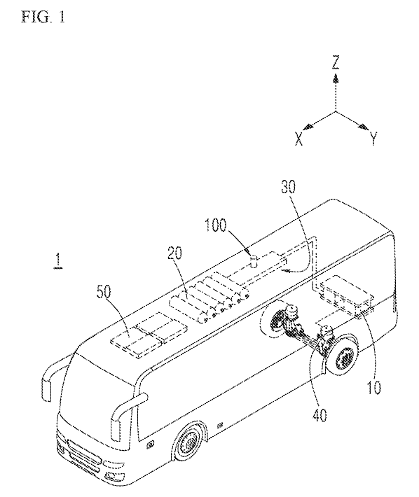

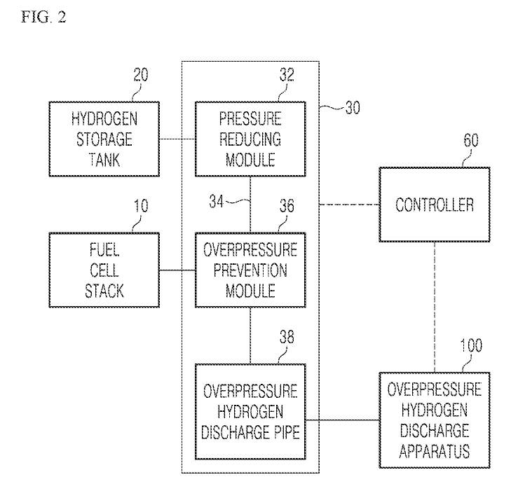

FIG. 1 shows an example of a hydrogen electric vehicle 1 equipped with an overpressure hydrogen discharge apparatus 100 according to one example of the present disclosure. FIG. 2 shows an example of a mounting position and coupling relationship of an overpressure hydrogen discharge apparatus provided in a hydrogen electric vehicle according to one example of the present disclosure.

As shown in FIGS. 1 and 2, an automatically openable and closable overpressure hydrogen discharge apparatus 100 according to one example of the present disclosure may be coupled to an upper end of an overpressure hydrogen discharge pipe 38 installed (e.g., a vertically oriented stainless-steel pipe, a composite-lined pipe, or a thermally shielded conduit) in the hydrogen electric vehicle 1.

The hydrogen electric vehicle 1 may be configured to generate electricity using hydrogen as fuel and may be configured to drive a motor with the generated electricity. A fuel cell stack 10, in which multiple fuel cells are combined, may be configured to cause hydrogen to react with oxygen, thereby converting the hydrogen into electrical energy and water (e.g., steam, liquid condensate, or vaporized droplets depending on the temperature and pressure conditions).

The hydrogen electric vehicle 1 may include the fuel cell stack 10, a hydrogen storage tank 20, a hydrogen supply unit 30, a drive motor 40, a battery module 50, and a controller 60 (e.g., a microprocessor-based ECU, a logic control circuit, or a hybrid digital-analog controller).

The fuel cell stack 10 may be configured to generate electrical energy using a chemical reaction between hydrogen and oxygen. In the fuel cell stack 10, water may be generated as a byproduct of the chemical reaction and may be discharged through a separate path (e.g., a water recovery line, a vent valve, or a condensate drain).

Hydrogen may be separated into electrons and protons (H⁺) at a negative electrode of the fuel cell stack 10. The electrons may flow through a connected external circuit, and the protons may move to a positive electrode of the fuel cell and be combined with oxygen to be converted into water (e.g., by passing through a proton exchange membrane or solid oxide layer).

Electrical energy generated in the fuel cell stack 10 may be supplied to the drive motor 40 or may be stored in the battery module 50 (e.g., a lithium-ion pack, a nickel-metal hydride unit, or a supercapacitor bank).

Hydrogen compressed at high pressure may be stored in the hydrogen storage tank 20 (e.g., at pressures of 700 bar, or higher in multi-layer composite vessels).

The hydrogen storage tank 20 may include a plurality of pressure-resistant containers (e.g., carbon fiber-wrapped aluminum tanks, polymer-lined tanks, or Type IV composite cylinders).

The hydrogen storage tank 20 may be configured to store hydrogen in the hydrogen electric vehicle 1 and to continuously supply hydrogen to the fuel cell stack 10 while the hydrogen electric vehicle 1 is being driven (e.g., during acceleration, cruising, or regenerative braking events).

The hydrogen storage tank 20 may be configured to store high-pressure hydrogen of approximately 700 bar, thereby allowing a larger amount of hydrogen to be stored in the hydrogen electric vehicle 1 (e.g., sufficient for a driving range of 300 km, 500 km, or more depending on vehicle type).

The hydrogen supply unit 30 may be configured to reduce the pressure of high-pressure hydrogen stored in the hydrogen storage tank 20 to a predetermined pressure or lower, and to supply the pressure-reduced hydrogen to the fuel cell stack 10 (e.g., by using a single-stage regulator, a dual-stage valve, or an integrated thermal management module).

The hydrogen supply unit 30 may include a pressure reducing module 32, a supply pipe 34, an overpressure prevention module 36, and the overpressure hydrogen discharge pipe 38 (e.g., arranged in a sequential flow path or in a manifold-type assembly).

The pressure reducing module 32 may be configured to reduce the pressure of hydrogen to the predetermined pressure or lower (e.g., approximately 20 bar), the hydrogen being stored in the hydrogen storage tank 20 in a compressed state under high pressure (e.g., 700 bar or higher).

The pressure-reduced hydrogen from the pressure reducing module 32 may be supplied to the fuel cell stack 10 through the supply pipe 34 (e.g., a stainless-steel line, a flexible hydrogen-rated hose, or a thermally insulated pipe).

The pressure-reduced hydrogen may be supplied to the fuel cell stack 10 through the overpressure prevention module 36 provided in the path of the supply pipe 34 (e.g., inline between the pressure reducing module and the stack inlet).

The overpressure prevention module 36 may be configured to check whether the hydrogen previously compressed at high pressure has been pressure-reduced by the pressure reducing module 32 to the predetermined pressure or lower (e.g., by using a pressure sensor, a mechanical relief valve, or an electronic control signal).

The overpressure prevention module 36 may be configured to allow only hydrogen having a pressure lower than the predetermined pressure to be supplied to the fuel cell stack 10 (e.g., by diverting excess pressure to a discharge pipe, venting to atmosphere, or triggering a warning signal).

To this end, the overpressure prevention module 36 may be configured to notify the controller 60 if overpressure hydrogen is detected in a predetermined section of the supply pipe 34, and the controller 60 may be configured to immediately discharge the overpressure hydrogen to the outside through the overpressure hydrogen discharge pipe 38 (e.g., via a solenoid valve, a burst disc actuator, or a fast-response electronic vent).

The overpressure hydrogen discharge pipe 38 may be connected to the supply pipe 34 provided between the pressure reducing module 32 and the fuel cell stack 10 (e.g., using a T-connector, a branch manifold, or an inline coupling).

That is, the overpressure hydrogen discharge pipe 38 may be provided in the hydrogen flow path before the hydrogen is supplied to the fuel cell stack 10 (e.g., positioned between the pressure reducing module and the fuel cell inlet manifold). The overpressure hydrogen discharge pipe 38 may be configured as a passage that is momentarily opened by the controller 60 to discharge hydrogen to the outside of the hydrogen electric vehicle 1 (e.g., during pressure spikes, valve failures, or stack-side backpressure events).

The outlet through which hydrogen passing through the overpressure hydrogen discharge pipe 38 is finally discharged may be configured to face upward in a vertical direction of the hydrogen electric vehicle 1 (e.g., through a roof-mounted nozzle, a vent stack, or an overhead exhaust duct).

The hydrogen storage tank 20 and the fuel cell stack 10 may be connected to each other through the hydrogen supply unit 30. The overpressure hydrogen discharge pipe 38 may be included in the hydrogen supply unit 30 (e.g., integrated into a supply manifold, mounted alongside pressure regulators, or housed within a thermal enclosure).

The overpressure hydrogen discharge pipe 38 shown in FIG. 2 is merely exemplary, and its installation position, shape, flow path configuration, or cross-sectional area may vary depending on examples to which the present disclosure is applied (e.g., for different vehicle classes, tank geometries, or regulatory layouts).

The hydrogen, pressure-reduced to the predetermined pressure or lower, may be supplied to the fuel cell stack 10 to generate electrical energy, and the drive motor 40 may be driven by the generated electrical energy to drive the vehicle (e.g., during startup, cruising, or acceleration).

The battery module 50 may be configured to store a portion of the electrical energy generated by the fuel cell stack 10 or to store electrical energy obtained through regenerative braking (e.g., during deceleration, downhill driving, or braking at traffic signals). The battery module 50 may be configured to store electrical energy and to additionally supply the stored energy to the motor under high power demand conditions, based on the driving situation of the hydrogen electric vehicle 1 (e.g., during hill climbs, overtaking, or initial acceleration from a stop).

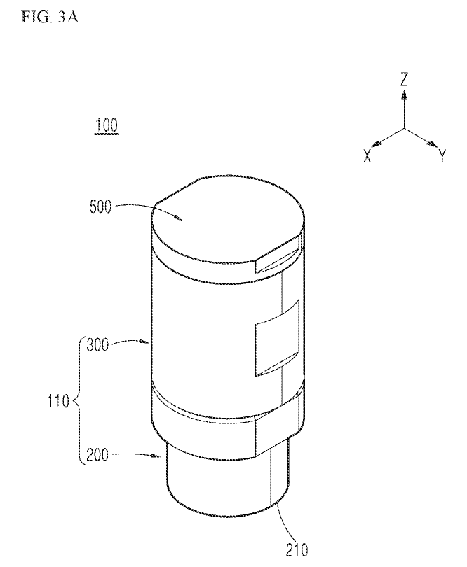

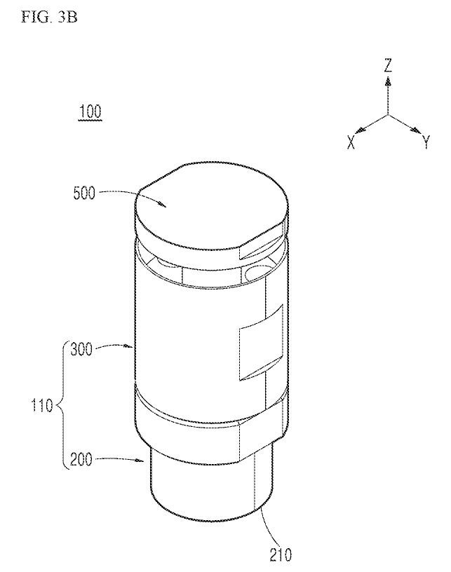

FIGS. 3A and 3B are perspective views respectively showing an example of a closed state and an open state of an overpressure hydrogen discharge apparatus 100 according to one example of the present disclosure.

As shown in FIG. 3A, an overpressure hydrogen discharge apparatus 100 according to one example of the present disclosure may be configured to be coupled to an upper end of the overpressure hydrogen discharge pipe 38, which is a hydrogen discharge pipe installed vertically upward in the hydrogen electric vehicle 1 (e.g., at the top of a pressure control manifold, behind the cabin firewall, or within the trunk compartment).

The overpressure hydrogen discharge apparatus 100 may be configured to be coupled to an upper passage of the overpressure hydrogen discharge pipe 38 and to prevent foreign substances from entering the interior of the overpressure hydrogen discharge pipe 38 (e.g., dust, rainwater, road debris, or insects, etc.).

As shown in FIG. 3B, the overpressure hydrogen discharge apparatus 100 according to one example of the present disclosure may be configured to open a passage to allow overpressure hydrogen to be smoothly discharged based on overpressure hydrogen flowing in from the overpressure hydrogen discharge pipe 38 at a pressure higher than a predetermined pressure (e.g., due to regulator failure, temperature-induced expansion, or malfunction in the supply unit). The overpressure hydrogen discharge apparatus 100 may also be configured with a structural design in which an opening is not exposed to the outside, so that foreign substances are prevented from entering the interior of the overpressure hydrogen discharge pipe 38 even during the discharge of the overpressure hydrogen (e.g., using a covered outlet, inward-facing channels, or shielding walls).

The overpressure hydrogen discharge apparatus 100 may also be configured to prevent chattering caused by the discharge pressure of the overpressure hydrogen, and to prevent physical forces, such as vibration or impact, from being concentrated on localized regions of the structure or at particular moments (e.g., when driving on rough roads, during sudden deceleration, or under strong crosswinds).

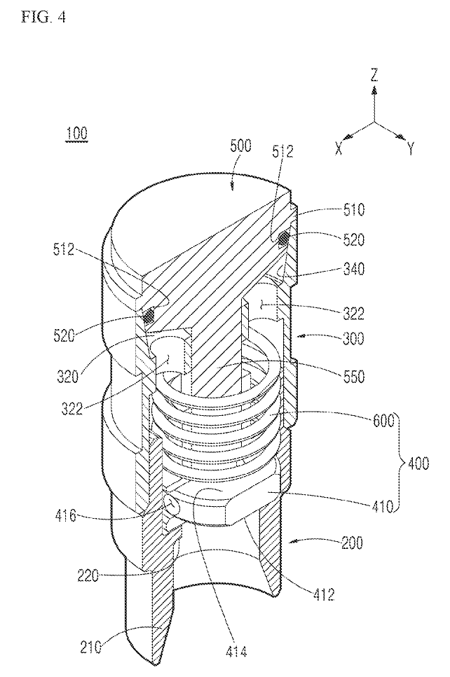

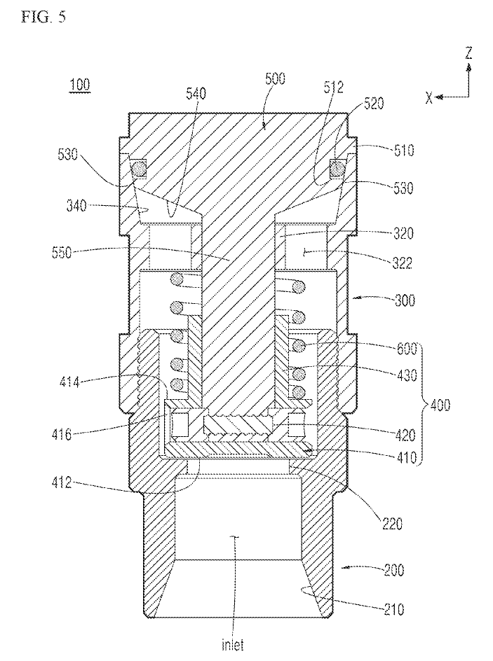

FIG. 4 is a sectional perspective view of an exemplary overpressure hydrogen discharge apparatus 100 according to one example of the present disclosure, and FIG. 5 is a cross-sectional view of an exemplary overpressure hydrogen discharge apparatus 100 according to one example of the present disclosure.

As shown in FIGS. 4 and 5, an overpressure hydrogen discharge apparatus 100 according to one example of the present disclosure may include a first body 110 (e.g., a cylindrical housing), a main stepped structure 220 (e.g., a stepped portion), a control plate 320 (e.g., a sealing plate), a lifting valve unit 400 (a vertically slidable valve assembly, a spring-biased sealing valve, a vertically movable valve body, a slidable sealing structure, a spring-loaded sealing member, etc.), and a main cover 500 (e.g., arranged in vertical sequence from the bottom to the top).

As viewed in the drawings, the first body 110 may be a housing that forms a gas flow path in a vertical direction. A pipe connection end 210 may be provided at a lower end of the first body 110 and connected to an open end of the overpressure hydrogen discharge pipe 38 (e.g., through a threaded joint, a compression fitting, or a welded interface).

The first body 110 may be integrally formed as a single structure; however, as shown, the first body 110 may be implemented in a form in which a main body 200 and a coupling body 300, which are separately manufactured as two parts, are joined together (e.g., using threaded engagement, a snap-fit mechanism, or adhesive bonding).

The pipe connection end 210 formed at the lower end of the first body 110 may be coupled to the upper open end of the overpressure hydrogen discharge pipe 38, and the upper portion of the first body 110 may be open at the top (e.g., to allow installation of internal valve components or facilitate upward gas flow).

The main body 200 may form the lower portion of the first body 110, and the coupling body 300 may be coupled to an upper portion of the main body 200 to form a middle portion and an upper portion of the first body 110 that extends upward (e.g., to provide adequate volume for valve operation and sealing space).

The structure in which the first body 110 may be divided into the main body 200 and the coupling body 300 may allow the lifting valve unit 400 (e.g., a spring-loaded sealing body configured to move vertically within the housing) and the main cover 500 to be more easily assembled inside the first body 110 (e.g., by inserting parts from the top, aligning guide shafts, or accessing internal fastening points) in one example of the present disclosure.

As shown, the main body 200 and the coupling body 300 may define a vertically continuous flow path in a coupled state, and threads formed on respective outer and inner circumferential surfaces may be engaged and coupled with each other (e.g., using fine-pitch threads, tapered threads, or locking thread compounds).

The pipe connection end 210 may be provided at the lower end of the main body 200 (e.g., as a molded extension, a threaded socket, or a pressure-rated fitting).

The pipe connection end 210 may be connected to the overpressure hydrogen discharge pipe 38. Specifically, the pipe connection end 210 may be coupled to an upper outlet of the overpressure hydrogen discharge pipe 38 (e.g., aligned using indexing marks or supported with vibration-damping mounts).

The pipe connection end 210 may be coupled to the upper end of the overpressure hydrogen discharge pipe 38, and allow a gas flow path formed inside the first body 110 to be linearly connected in a vertical direction to a gas flow path within the overpressure hydrogen discharge pipe 38 through which hydrogen rises (e.g., during normal venting, emergency discharge, or malfunction events).

The pipe connection end 210 may be coupled to the overpressure hydrogen discharge pipe 38 through a fastening means (e.g., threaded fitting, clamping collar, or welded joint). A method of firmly coupling the overpressure hydrogen discharge pipe 38, which is a pipe extending vertically upward, with the overpressure hydrogen discharge apparatus 100 according to one example of the present disclosure in a fluid-communicating manner may be implemented in an appropriate manner depending on examples to which the present disclosure is applied (e.g., using welding, clamping, or high-pressure fittings).

The main stepped structure 220 may be provided at a lower inner portion of the first body 110 adjacent to the pipe connection end 210 (e.g., to act as a valve seat, flow restriction, or guide for vertical sealing components).

The main stepped structure 220 may be a stepped structure formed along an inner circumferential surface of the main body 200. The main stepped structure 220 may define a passage that extends vertically to provide the gas flow path in a vertical direction (e.g., supporting a sealing piston, restricting reverse flow, or aligning internal components).

The main stepped structure 220 may be positioned adjacent to the pipe connection end 210 and provided in the form of a step protruding inward from an inner side of the main body 200 above the pipe connection end 210 (e.g., as an annular ridge, a shoulder with radial taper, or a machined shelf).

The control plate 320 may be located above the main stepped structure 220 and may be provided in an internal space of the first body 110 (e.g., secured between upper threaded sections, supported by internal ribs, or seated on a retaining shoulder). With reference to FIGS. 4 and 5, the control plate 320 may be a plate-shaped member having a predetermined thickness and may horizontally block the gas flow path that is formed in a vertical direction inside the coupling body 300 (e.g., acting as a pressure barrier, a flow distributor, or a valve seat).

A lifting opening through which a lifting shaft 550 (e.g., a shaft) extends vertically may be formed at a central portion of the control plate 320. In addition, a plurality of dispersion discharge holes 322 may be formed in a radial pattern around a center point of the lifting shaft 550 (e.g., arranged in concentric rings, starburst configuration, or evenly spaced angular segments). Each dispersion discharge hole 322 is a passage formed vertically through the control plate 320 (e.g., drilled, cast, or laser-cut holes).

The dispersion discharge holes 322 may be provided in plurality, and a total cross-sectional area of all the dispersion discharge holes 322 may be set to be smaller than a cross-sectional area of the passage defined by the main stepped structure 220 (e.g., to limit the discharge rate, reduce pressure spikes, or promote staged decompression).

This configuration may allow the overpressure hydrogen to be gradually pressure-reduced in stages while passing through gas flow paths defined by the main stepped structure 220 and the control plate 320, in the case where the overpressure hydrogen is discharged instantaneously at high pressure through the overpressure hydrogen discharge pipe 38 (e.g., during valve failure, regulator malfunction, or sudden tank venting).

The plurality of dispersion discharge holes 322 formed in the control plate 320 may be evenly distributed in radial spaces around the center point (e.g., using a circular, star-shaped, or symmetric grid pattern).

This arrangement may allow the gas flow inside the first body (110) to be evenly distributed and not concentrated to one side in any section of the gas flow path (e.g., reducing turbulence, asymmetric pressure zones, or localized erosion).

Each dispersion discharge hole 322 may be implemented with various cross-sectional shapes, in addition to a circular shape, as long as the gas flow path of the overpressure hydrogen may be maintained vertically and uniformly (e.g., elliptical, rectangular, or star-shaped profiles).

The lifting valve unit 400 may be provided in a space formed between the main stepped structure 220 and the control plate 320 within the internal space of the first body 110 (e.g., to act as a pressure-responsive sealing assembly).

The lifting valve unit 400 may include a second body 410 (e.g., a sealing piston) having a predetermined thickness, the second body including a lower sealing surface 412 having an area larger than that of the passage defined by the main stepped structure 220, and an upper corresponding surface 414 formed on the opposite side of the lower sealing surface 412 (e.g., to interface with a return spring, a guide pin, or a support ring).

The second body 410 may include the lower sealing surface 412 and the upper corresponding surface 414, which are arranged to be parallel to each other with respect to a horizontal plane, and a circumferential surface of the second body 410, which forms a side wall along the circumferences of the lower sealing surface 412 and the upper corresponding surface 414, may be in contact, at least in part, with an inner surface of the gas flow path formed in the first body 110 by a predetermined area and may be slidable vertically (e.g., guided by a cylindrical bore, a linear track, or a bushing interface).

The lower sealing surface 412 of the second body 410 may be placed on the main stepped structure 220 to close the passage defined by the main stepped structure 220 (e.g., under spring bias, gravity, or vacuum hold).

Based on an external force equal to or greater than a predetermined magnitude being applied to the lower sealing surface 412 in a +Z-axis direction, the second body 410 may move linearly upward to open the passage defined by the main stepped structure 220 (e.g., when overpressure hydrogen pushes against the valve).

The ascent height of the lower sealing surface 412, which is opened by the external force, may be adjusted based on elastic characteristics of an elastic unit 600 (e.g., a spring, preload, or travel stop).

The elastic unit 600 may be a compression spring. The elastic unit 600 may have a lower end supported by the upper corresponding surface 414 of the second body 410 and may have an upper end in contact with a lower surface of the control plate 320 (e.g., retained in a spring seat, a cavity, or a recessed groove).

That is, the elastic unit 600 may be interposed between the lower surface of the control plate 320 and the upper corresponding surface of the second body 410, and may be elastically deformed based on a force equal to or greater than a predetermined magnitude being applied in a vertical direction, and may return to its original shape based on removal of the external force (e.g., through spring recovery, pressure equalization, or backflow stabilization).

The elastic unit 600 may push the second body 410 toward the main stepped structure 220 from the control plate 320 to return the second body 410 to its original position based on removal of the external force applied in a vertical direction (e.g., to reseal the passage and prevent unintended flow).

An upper portion of the first body 110 is formed as an open structure, and the main cover 500 may be provided to selectively open or close an upper portion of the first body 110 (e.g., for maintenance, inspection, or controlled venting).

The main cover 500 may be coupled to the upper portion of the first body 110 to close the upper opening (e.g., using bolts, snap-fits, or a threaded interface).

Based on the external force equal to or greater than a predetermined magnitude being applied to the lower sealing surface 412 in a +Z-axis direction, the lifting valve unit 400 may ascend (e.g., due to a sudden pressure surge, abnormal regulator output, or upstream valve malfunction). As a result, the passage defined by the main stepped structure 220 may be opened, and the upper portion of the first body 110 may also be opened. Accordingly, the overpressure hydrogen may be discharged (e.g., safely vented to atmosphere, redirected through a shielded path, or dispersed vertically).

The main cover 500 may include a peripheral projection 510. The peripheral projection 510 may have a size and shape corresponding to a top peripheral surface of the first body 110 (e.g., circular, square, or polygonal flange configurations).

The lifting shaft 550 may vertically extend downward from a central lower portion of the main cover 500 (e.g., as a single molded rod, a machined shaft, or a press-fitted pin).

At least a portion of a lower end of the lifting shaft 550 may vertically pass through a central portion of the upper corresponding surface 414 of the second body 410 and may be inserted into an interior of the second body 410 (e.g., through a press fit, a guide hole, or an alignment collar).

The upper corresponding surface 414 of the second body 410 may include a guide stopper 430 having a predetermined length. The guide stopper 430 may be configured to surround and fix an outer circumference of the lifting shaft 550 (e.g., using a cylindrical collar, a guide bushing, or a vertical sleeve).

The guide stopper 430 may extend upward from the upper corresponding surface 414 of the second body 410 and may surround the outer circumference of the lifting shaft 550 with a predetermined thickness while being in contact with the outer circumference (e.g., with a tolerance fit to guide motion without excessive friction).

A top peripheral surface of the guide stopper 430 may be formed to be parallel to the lower surface of the control plate 320 (e.g., to provide a uniform stopping interface).

The guide stopper 430 may perform a role of firmly fixing the lifting shaft 550 to the second body 410 and may also perform a role of limiting a range in which the second body 410 is allowed to move upward (e.g., to avoid mechanical overextension or component disassembly).

Based on an external force equal to or greater than the predetermined magnitude being applied to the lower sealing surface 412 in a +Z-axis direction, the lifting valve unit 400 may move upward against an elastic resistance applied by the elastic unit 600 (e.g., a compression spring, Belleville washer, or elastomeric bumper). At this time, based on the guide stopper 430 reaching a predetermined height, the top peripheral surface of the guide stopper 430 may come into contact with the lower surface of the control plate 320 to prevent the lifting valve unit 400 from further ascending beyond the predetermined height (e.g., to enforce a mechanical limit on displacement).

An ascent height of the lifting valve unit 400 may be determined based on an elastic deformation amount of the elastic unit 600 (e.g., depending on spring constant, preload force, or compression distance), and a maximum ascent height may be limited by the guide stopper 430 (e.g., acting as a mechanical stop to prevent over-extension or structural interference). In the overpressure hydrogen discharge apparatus 100 according to one example of the present disclosure, the ascent height of the lifting valve unit 400 may vary based on the elastic deformation amount of the elastic unit 600 (e.g., depending on spring stiffness, preload, or accumulated pressure).

An additional coupling means may further be provided at the lower end of the lifting shaft 550 to more firmly couple the lifting shaft 550 to the second body 410 of the lifting valve unit 400 (e.g., using screws, pins, or interlocking tabs).

As shown, the second body 410 may have a horizontal fastening hole 416 formed to penetrate its inner space in a lateral direction (e.g., perpendicular to the lifting shaft’s axis).

A screw fastening hole 552 may be formed at a lower end of the lifting shaft 550 to be aligned with the horizontal fastening hole 416. A linear fastening screw 420 may pass through the horizontal fastening hole 416 and the screw fastening hole 552, which are aligned in a straight line, so that the second body 410 and the lifting shaft 550 may be coupled to each other (e.g., forming a secure pivot-free rigid connection).

Accordingly, as the second body 410 ascends or descends in a vertical direction, the lifting shaft 550 may also ascend or descend together like a rigid body integrally formed with the second body 410 (e.g., moving as a single part to maintain structural integrity).

An upper end of the lifting shaft 550 may be connected to the center lower portion of the main cover 500. As described above, the peripheral projection 510 may have a size and shape (e.g., circular, polygonal, or elliptical) to cover and close the top peripheral surface of the first body 110 (e.g., ensuring a snug fit to maintain sealing integrity and structural alignment). The lower surface of the peripheral projection 510 may come into contact with the top peripheral surface of the first body 110 so that the upper portion of the first body 110 may be covered and closed (e.g., forming a seal against gas leakage or environmental intrusion).

The main cover 500 may include a sealing groove 512 formed around the lower portion adjacent to the peripheral projection 510 (e.g., encircling the inner circumference of the cover skirt).

The sealing groove 512 may be formed around the lower portion adjacent to the peripheral projection 510. The sealing groove 512 may be formed in an annular recessed shape (e.g., circular channel, square-cut trench, or V-groove).

The sealing groove 512 may be a groove recessed inward with a predetermined width and depth toward the center point of the lifting shaft 550. A closing member 520 manufactured in a shape corresponding to the sealing groove 512 may be coupled to the sealing groove 512. The closing member 520 may include a sealing member (e.g., an annular gasket, an O-ring, or a composite elastomer ring).

The closing member 520 may be provided such that at least a portion thereof protrudes outward from the sealing groove 512, and may come into contact with an upward expansion portion 340 of the first body 110 to seal an internal space of the first body 110 from an external environment (e.g., preventing ingress of dust, water, or road debris, or exposure to external thermal or chemical contaminants). The upward expansion portion 340 may be an inner surface formed along an inner circumferential edge of the top peripheral surface of the first body 110 and may be formed as an inclined surface that narrows the central passage from the top to the bottom (e.g., for gas guidance, compression sealing, or debris deflection).

A plurality of the closing members 520 may be provided at predetermined vertical intervals (e.g., spaced apart depending on sealing performance requirements).

A sealing inclined surface 530 may be provided at a lower portion of the peripheral projection 510, adjacent to the sealing groove 512, the sealing inclined surface 530 being formed to be inclined such that its cross-sectional area decreases toward a lower side (e.g., forming a tapered profile, a chamfer, or a conical interface).

The sealing inclined surface 530 may come into contact with the upward expansion portion 340 of the first body 110 (e.g., under compression from elastic loading during closed conditions).

The closing member 520 may be interposed between the sealing inclined surface 530 and the upward expansion portion 340. The closing member 520 may be made of a highly elastic material (e.g., silicone, EPDM rubber, or fluoropolymer-based compounds). The sealing inclined surface 530 and the upward expansion portion 340 may be more smoothly coupled via the closing member 520, which may provide an enhanced sealing effect (e.g., improved gas tightness, vibration absorption, or thermal resistance).

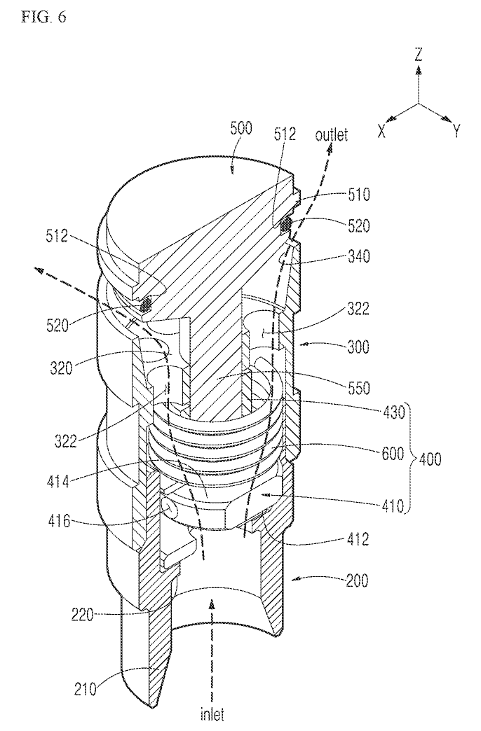

FIG. 6 is a sectional perspective view showing an exemplary open state of an overpressure hydrogen discharge apparatus 100 according to one example of the present disclosure.

As shown in FIG. 6, when the overpressure hydrogen flows upward from the overpressure hydrogen discharge pipe 38, the overpressure hydrogen may press the lower sealing surface 412 in the +Z-axis direction (e.g., due to pressure spikes, stack malfunctions, or regulator failure).

If the pressure of the overpressure hydrogen is equal to or higher than a predetermined pressure, the lifting valve unit 400 may ascend, and the passage defined by the main stepped structure 220 may be opened (e.g., to relieve internal buildup and avoid system overloading).

The overpressure hydrogen may flow upward through the passage defined by the main stepped structure 220 and pass through the dispersion discharge holes 322 of the control plate 320 (e.g., dispersing flow to reduce or minimize jetting or localized thermal impact).

The sealing inclined surface 530, the closing member 520, and the peripheral projection 510 of the main cover 500 may ascend together based on the ascent of the lifting valve unit 400, so that the overpressure hydrogen may be discharged from the upper portion of the first body 110 (e.g., through a safe vertical exhaust outlet).

For example, the main cover 500 may further include an upward curved surface 540 so that the overpressure hydrogen passing through the plurality of dispersion discharge holes 322 may be smoothly discharged to the upper outer side (e.g., reducing backpressure, turbulence, or condensation).

The upward curved surface 540 may be formed on at least a portion of the bottom surface of the main cover 500. The upward curved surface 540 may be a curved surface formed between the outer circumference of the lifting shaft 550 and the inner circumference of the sealing inclined surface 530, may be inclined upward as it extends radially outward from the lifting shaft 550, and may guide the discharged overpressure hydrogen (e.g., in a dome, cone, or parabolic profile for aerodynamic flow guidance).

In the overpressure hydrogen discharge apparatus 100 according to one example of the present disclosure, most of the components, including the first body 110, the main body 200, the coupling body 300, the lifting valve unit 400, the second body 410, and the main cover 500, may be made of stainless steel (SUS) (e.g., SUS304, SUS316, or duplex stainless alloys).

By using stainless steel (SUS), a probability of damage or deformation of some components may be significantly reduced (e.g., against corrosion, high-pressure fatigue, or thermal cycling).

The overpressure hydrogen discharge apparatus 100 according to one example of the present disclosure, with its major components made of stainless steel (SUS), may have improved durability, resulting in an extended operational lifespan, and may be assembled with enhanced structural integrity (e.g., better resistance to hydrogen embrittlement or mechanical wear).

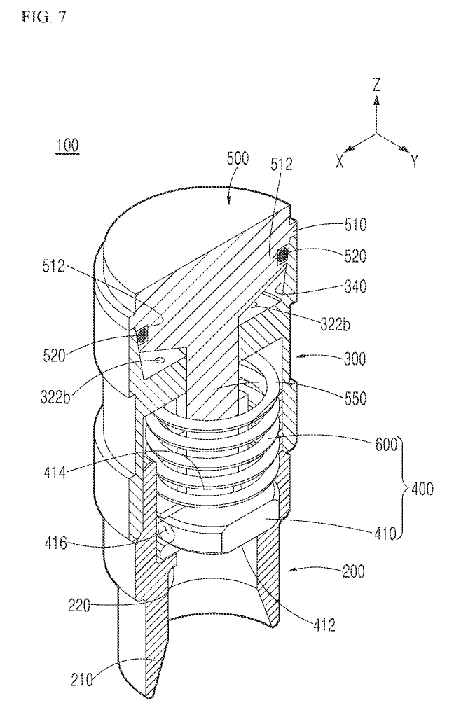

FIG. 7 is a sectional perspective view of an exemplary overpressure hydrogen discharge apparatus 100 according to another example of the present disclosure.

As shown in FIG. 7, in another example of the present disclosure, the overpressure hydrogen discharge apparatus 100 may have the dispersion discharge holes 322b formed to have a relatively small diameter in the control plate 320. Specifically, according to examples to which the present disclosure is applied, the number, arrangement, individual area, cross-sectional shape, and the like of the dispersion discharge holes 322b formed in the control plate 320 may be variously modified (e.g., to circular, elliptical, rectangular, or star-shaped geometries).

Such modifications may be designed to implement an appropriate differential pressure according to examples of the present disclosure, as the overpressure hydrogen enters through the lowermost pipe connection portion 210, opens the passage defined by the lower sealing surface 412, flows into the space between the main stepped structure 220 and the control plate 320, and then passes through the control plate 320 (e.g., generating backpressure moderation, flow conditioning, or nozzle-like regulation).

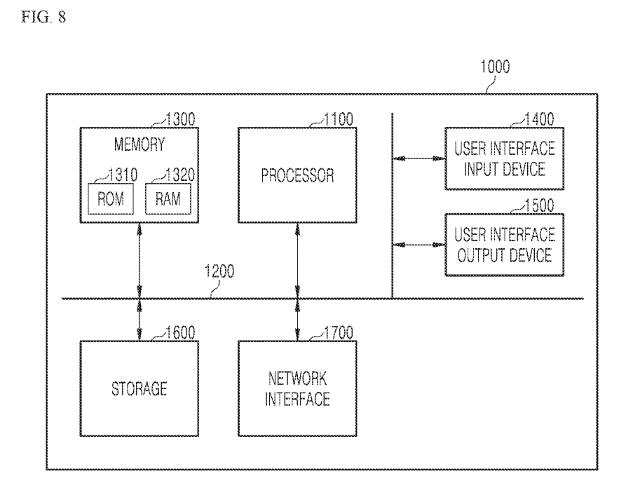

FIG. 8 shows an example computing system (e.g., a computing device of a vehicle or any other apparatus). One or more controllers, processors, etc. described herein, such as one or more components of the hydrogen electric vehicle 1, and any other components and devices disclosed herein, may be implemented by or in the computing system as shown in FIG. 8.

A computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random-access memory (RAM). Communication interface(s) (also referred to as communication device(s), communicator(s), communication module(s), communication unit(s), etc.), such as the network interface 1700, may allow software and/or data to be transferred between a device and one or more external devices, and/or between one or more components of a device.

Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example example(s) disclosed in the specification may be directly implemented with a hardware module, a software module, or a combination of the hardware module and the software module, which is executed by the processor 1100. The software module may reside on a storage medium (e.g., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

Examples of the present disclosure are not limited to those mentioned above, and other examples that are not mentioned above may be clearly understood by those skilled in the art from the following description.

An example of the present disclosure may provide an automatically openable and closable overpressure hydrogen discharge apparatus for a hydrogen electric vehicle, including a first body configured as a housing that forms a straight-section gas flow path in a vertical direction, the first body having a pipe connection end provided at a lower portion thereof and connected to a hydrogen discharge pipe, and the first body having an upper portion that is open, a main stepped structure formed at a central portion of the first body, the main stepped structure defining a passage of a predetermined size that extends vertically to provide communication between the pipe connection end and an internal space of the first body, a control plate that is a horizontal wall disposed above the main stepped structure inside the first body and has a plurality of dispersion discharge holes formed perpendicular to the horizontal direction, a lifting valve unit disposed inside the first body, the lifting valve unit including a flat sealing surface formed on a lower side, the flat sealing surface configured to cover and close the passage defined by the main stepped structure, and the lifting valve unit being configured to be lifted to open the passage based on an external force greater than a predetermined magnitude being applied upward on the flat sealing surface, and a main cover connected to the lifting valve unit through a lifting shaft, the main cover being configured to move upward and downward together with the lifting valve unit to open or close the upper portion of the first body.

The lifting valve unit may include a second body having a lower surface formed as a flat sealing surface, and an upper surface formed as an upper corresponding surface that faces upward and in parallel with the flat sealing surface, wherein at least a portion of a lower end of the lifting shaft is received and fixed in a vertical direction at a central portion of the upper corresponding surface.

The lifting valve unit may include a guide stopper formed on the upper corresponding surface of the second body, the guide stopper surrounding an outer circumferential surface of the lifting shaft with a predetermined thickness and extending upward.

The automatically openable and closable overpressure hydrogen discharge apparatus for a hydrogen electric vehicle may include an elastic unit disposed between the upper corresponding surface of the second body and the lower surface of the control plate, and configured to surround the outer circumferential surface of the lifting shaft, the elastic unit being configured to be elastically deformed based on an external force being applied such that a gap between the upper corresponding surface and the lower surface of the control plate is reduced, and configured to be elastically restored to return the gap to its original state based on removal of the external force.

The guide stopper may be configured to prevent the second body from ascending to approach the control plate closer than a predetermined distance.

The second body may include a horizontal fastening hole laterally formed through an interior portion of the second body. The lifting shaft may include a screw fastening hole formed in the lower end portion thereof that is inserted into the second body perpendicular to the upper corresponding surface, the screw fastening hole being positioned to be aligned with the horizontal fastening hole. The second body and the main cover may be fixed to each other by a fastening screw extending across the horizontal fastening hole and the screw fastening hole.

The control plate may include an opening formed at a center thereof to allow the lifting shaft to pass through in a vertical direction, and a plurality of dispersion discharge holes may be formed to allow gas to flow evenly in all directions around the lifting shaft passing through the control plate.

A cross-sectional area of the passage defined by the main stepped structure may be greater than a total cross-sectional area of the plurality of dispersion discharge holes formed in the control plate.

The main cover may include a peripheral projection configured to be in contact with and cover a top peripheral surface of the first body, a sealing groove formed around a lower portion adjacent to the peripheral projection, and a closing member inserted into the sealing groove, the closing member being disposed to surround a lower portion of the peripheral projection and configured to seal the internal space of the first body from an external environment when the main cover covers the upper portion of the first body.

The main cover may include a sealing inclined surface formed as at least a portion of a surface adjacent to the sealing groove below the peripheral projection, the sealing inclined surface being inclined inward as it extends downward, and an upwardly curved surface formed between the sealing inclined surface and the lifting shaft, along the inner circumferential edge of the sealing inclined surface, the upwardly curved surface being radially inclined upward as it extends farther from the lifting shaft.

The first body may include an upward expansion portion formed along a predetermined length section of an inner circumferential surface from an inner circumferential edge of the top peripheral surface of the first body that is open at the top, the upward expansion portion having an inclined surface at a constant angle, the inclined surface being formed such that an open area becomes narrower toward a lower side.

According to examples of the present disclosure, by adopting a structure for stepwise pressure reduction during discharge of overpressure hydrogen, a sudden high discharge pressure may be prevented from being applied to an overpressure hydrogen discharge apparatus.

According to examples of the present disclosure, by sequentially reducing the pressure of discharged overpressure hydrogen, chattering of a cover unit caused by the discharge pressure of the overpressure hydrogen may be prevented.

According to examples of the present disclosure, vibration and impact generated during discharge of overpressure hydrogen may be reduced, thereby improving the durability of an overpressure hydrogen discharge apparatus.

According to examples of the present disclosure, since an outlet through which overpressure hydrogen is discharged is not exposed to the outside, foreign substances may be prevented from entering.

The above-described examples of the present disclosure have been explained with reference to the accompanying drawings. The examples and drawings described above are merely illustrative, and it will be apparent that various modifications may be made without departing from the scope of the technical spirit of the present disclosure.

The examples described herein should be regarded as part of the present disclosure, and the scope of the present disclosure is not limited to these examples.

In addition, even if actions or effects resulting from specific configurations are not explicitly described in the disclosed examples, foreseeable actions or effects of such configurations are to be included within the scope of the present disclosure.

The present disclosure described as above is not limited by the examples described herein and the accompanying drawings. It should be apparent to those skilled in the art that various substitutions, changes and modifications which are not exemplified herein but are still within the spirit and scope of the present disclosure may be made. Therefore, the scope of the present disclosure is defined not by the detailed description, but by the claims and their equivalents, and all variations within the scope of the claims and their equivalents are to be construed as being included in the present disclosure.

1. An apparatus for a hydrogen electric vehicle, the apparatus comprising:
a first body configured as a housing that forms a gas flow path in a vertical direction, wherein the first body comprises a pipe connection end, wherein the pipe connection end is provided at a lower portion of the first body and connected to an overpressure hydrogen discharge pipe, and wherein the first body comprises an upper portion that is open at a top of the first body;
a main stepped structure formed at a central portion of the first body, wherein the main stepped structure defines a passage of a predetermined size that extends vertically, and wherein the passage is configured to provide a gas flow path between the pipe connection end and an internal space of the first body;
a control plate provided above the main stepped structure, wherein the control plate has a predetermined thickness, wherein the control plate is configured to partition the internal space of the first body into an upper region and a lower region, and wherein the control plate comprises a plurality of dispersion discharge holes that are vertically open;
a lifting valve unit provided in a space between the main stepped structure and the control plate, wherein the lifting valve unit is configured to be in contact with a top peripheral surface of the main stepped structure to close the passage, and configured to, based on an external force greater than a predetermined magnitude being applied upwardly, ascend and open the passage; and
a main cover connected to the lifting valve unit through a lifting shaft, wherein the main cover is configured to move upward and downward together with the lifting valve unit to open or close the upper portion of the first body.

2. The apparatus of claim 1, wherein the lifting valve unit comprises a second body, wherein the second body comprises a lower surface formed as a flat sealing surface, and an upper surface, wherein the upper surface is formed as an upper corresponding surface that faces upward and in parallel with the flat sealing surface, and wherein at least a portion of a lower end of the lifting shaft is vertically inserted into a central portion of the upper corresponding surface and coupled to the second body.

3. The apparatus of claim 2, wherein the lifting valve unit comprises an elastic unit, wherein the elastic unit is configured to, based on an external force greater than the predetermined magnitude being applied upwardly to the flat sealing surface of the second body, be elastically deformed in a space between the upper corresponding surface and a lower surface of the control plate to cause the second body to ascend, and wherein the elastic unit is further configured to absorb stress in a vertical direction during the deformation of the elastic unit, and configured to be restored, based on removal of the external force, to an original shape of the elastic unit such that the flat sealing surface of the second body returns to close the passage defined by the main stepped structure.

4. The apparatus of claim 2, wherein the lifting valve unit comprises a guide stopper extending from the upper corresponding surface to a predetermined height, and wherein the guide stopper is configured to be in contact with and encompassing an outer circumferential surface of the lifting shaft with a predetermined thickness.

5. The apparatus of claim 4, wherein the guide stopper is configured to limit a peak height to which the second body is allowed to ascend toward the control plate.

6. The apparatus of claim 2, wherein the second body comprises a horizontal fastening hole that is laterally formed through an interior portion of the second body, wherein the lifting shaft comprises a screw fastening hole that is formed in a lower end portion of the lifting shaft, wherein the lower end portion is inserted into the second body in a direction perpendicular to the upper corresponding surface, wherein the screw fastening hole is positioned to align with the horizontal fastening hole, and wherein the second body and the main cover are fixed to each other by a fastening screw that extends across the horizontal fastening hole and the screw fastening hole.

7. The apparatus of claim 2, wherein the control plate comprises an opening formed at a central portion of the control plate to allow the lifting shaft to pass vertically along a longitudinal direction of the lifting shaft, and wherein the plurality of dispersion discharge holes are formed in radial regions around a center point of the lifting shaft, such that gas passes through the control plate with a uniformly distributed flow rate.

8. The apparatus of claim 2, wherein a cross-sectional area of the passage defined by the main stepped structure is greater than a total cross-sectional area of the plurality of dispersion discharge holes formed in the control plate.

9. The apparatus of claim 1, wherein the main cover comprises:
a peripheral projection configured to be in contact with a top peripheral surface of the first body and cover the top peripheral surface of the first body;
a sealing groove formed around a lower portion adjacent to the peripheral projection in parallel with the peripheral projection, wherein the sealing groove has a predetermined width; and
a closing member inserted into the sealing groove, wherein the closing member is configured to surround the lower portion of the peripheral projection and configured to seal, based on the main cover being in a state that covers the upper portion of the first body, the internal space of the first body from an external environment.

10. The apparatus of claim 9, wherein the main cover comprises:
a sealing inclined surface formed on a lower portion of the peripheral projection and adjacent to the sealing groove, wherein the sealing inclined surface is inclined inward as the sealing inclined surface extends downward; and
an upwardly curved surface formed between the sealing inclined surface and the lifting shaft along an inner circumferential edge of the sealing inclined surface, wherein the upwardly curved surface is radially inclined upward as the upwardly curved surface extends farther from the lifting shaft.

11. The apparatus of claim 9, wherein the first body comprises an upward expansion portion formed in a predetermined length region of an inner circumferential surface along an inner circumferential edge of the upper portion that is open at the top of the first body, wherein the upward expansion portion comprises an inclined surface that is upwardly expanded such that a cross-sectional area of the gas flow path increases toward the upper portion.

12. An apparatus of a hydrogen electric vehicle, the apparatus comprising:
a housing comprising a lower end and an upper end, wherein the lower end is configured to be connected to a hydrogen discharge pipe;
a main stepped structure disposed inside the housing and defining a vertically extending passage between the lower end and an internal space of the housing;
a control plate positioned above the main stepped structure within the housing, wherein the control plate comprises a plurality of dispersion discharge holes that extend in a direction perpendicular to the control plate;
a sealing piston disposed between the main stepped structure and the control plate, wherein the sealing piston comprises a lower surface and an upper surface, wherein the lower surface of the sealing piston is configured to seal the vertically extending passage, and wherein the upper surface of the sealing piston is spaced apart from the control plate in a rest position;
a spring disposed between the upper surface of the sealing piston and a lower surface of the control plate, wherein the spring is configured to be compressed based on the sealing piston being displaced toward the control plate;
a lifting shaft fixed at a lower end to the sealing piston and extending upward through a central opening in the control plate;
a main cover fixed to an upper end of the lifting shaft and positioned above the housing, wherein the main cover is configured to close the upper end of the housing in a rest position and move upward together with the lifting shaft based on the sealing piston being lifted by hydrogen pressure; and
an annular gasket disposed between the main cover and the upper end of the housing, wherein the annular gasket is configured to be compressed to form a seal in a rest position and separated during upward movement of the main cover.

13. The apparatus of claim 12, wherein the lifting shaft is secured to the sealing piston by a fastening screw that passes through a horizontal hole formed in the sealing piston and a screw hole formed in a lower end portion of the lifting shaft.

14. The apparatus of claim 12, further comprising a guide stopper formed on the sealing piston, wherein the guide stopper surrounds the lifting shaft and is configured to limit upward movement of the sealing piston by contacting a lower surface of the control plate.

15. The apparatus of claim 12, wherein the spring is a compression coil spring concentrically arranged around the lifting shaft.

16. The apparatus of claim 12, wherein the plurality of dispersion discharge holes are distributed radially around the lifting shaft, and wherein the control plate comprises a total cross-sectional area of the plurality of dispersion discharge holes is smaller than a cross-sectional area of the vertically extending passage.

17. The apparatus of claim 12, wherein the sealing piston is configured such that a circumferential surface of the sealing piston contacts an inner surface of the housing and slides vertically within the housing during upward and downward movement of the sealing piston.

18. The apparatus of claim 12, wherein the annular gasket is positioned within a recessed groove formed in the main cover and is pressed against an upwardly inclined sealing surface formed on an inner wall of the housing.

19. The apparatus of claim 12, wherein the main cover further comprises an upwardly curved surface formed between the lifting shaft and the annular gasket, wherein the upwardly curved surface is configured to direct discharged hydrogen flow outward and upward.

20. The apparatus of claim 12, wherein the housing, the sealing piston, the control plate, and the main cover are each formed from stainless steel.
